(19) United States
(12) Patent Application Publication
(10) Pub. No.: US 2011/0181632 A1
(43) Pub. Date: Jul. 28, 2011

(54) METHOD AND DRIVER FOR ACTUATING A PASSIVE-MATRIX OLED DISPLAY

(75) Inventors: Chihao Xu, Saarbruecken (DE); Andreas Karrenbauer, Konstanz (DE); Cosmin Codrea, Sterrebeek (BE)

(73) Assignee: X-Motive GmbH, Saarbruecken (DE)

(21) Appl. No.: 12/993,081

(22) PCT Filed: May 13, 2009
(86) PCT No.: PCT/EP2009/003397

§ 371 Date: Mar. 11, 2011

(30) Foreign Application Priority Data
May 19, 2008 (DE) 10 2008 024 126.1

(51) Int. Cl. G09G 3/32; G09G 5/10

(52) U.S. Cl. 345/691; 345/77

(57) ABSTRACT

A method and unit for controlling a passive matrix-OLED-display with OLEDs assembled in matrix form, wherein columns for controlling an OLED are connected with a current source, and rows are connected consecutively during row addressing time. The lightness of a pixel located on the intersection point of a column with an addressed row is influenced by the turn-on time being within the row addressing time and by the amplitude of the column current. To reach an energy-efficient control it is proposed to control the lightness of the pixel subject to the charge quantity converted into light and subject to a charge quantity during a post luminescence time and converted into light by switching the column potential-free during post luminescence time and considering the charge quantity stored in the capacity of OLEDs before the addressing at determination of the charge quantity converted at the OLED.

The invention concerns a method and a unit to control a passive matrix-OLED-display with OLEDs assembled in matrix form according to the topic of claim 1, whereby the columns are connected individually, or may be several columns or all columns simultaneously are connected with a current source for driving an OLED or are supplied a voltage, and the rows are connected resp. addressed continuously one after another for the duration of the row addressing time, so that the OLEDs are supplied with current at the intersection points of the columns with the activated rows and glow. By addressing the rows, they are scanned one by one at a voltage, which was applied for current feeding the OLED assembled on this column. The charge converted at an OLED leads to the lightness of a pixel, located on the intersection point of a column with an addressed row, and this lightness is influenced by the turn-on time being within the row-addressing-time, and by the amplitude of the column current. In particular, also the capacities of all OLEDs of the column are charged by the column current, independent if the OLEDs at that time are being activated or not.

The whole display can also be assembled by one or several displays operated in parallel, spatially complementing one another. In the notation of the application, the serials driven with current are considered as columns, and the consecutively activated resp. addressed serials are considered as rows, regardless of a possibly horizontal and vertical arrangement of columns and/or rows. The terms columns and rows are defined by the function mentioned above. In a typical application the columns form the anodes and the rows form the cathodes of the passive matrix-OED-display.

The intrinsic capacities of an OLED are coupled with each other in a passive matrix-display. By switching-on and switching-off the OLED (organic light emitting diode) the capacity is in each case charged resp. discharged. Therefore these capacities generate for their control a relatively high power loss in a passive matrix-display corresponding to the used driving schemes. The power loss increases quadratically with the number of the rows. This problem leads to a hesitant usage of the passive matrix-OLED-displays in high-quality applications, because these applications do not tolerate the relatively high power loss.

As the capacities of the OLED are coupled with each other, an unwanted flashing of passive i.e. not controlled pixels, caused by the capacitive coupling, can appear, unless this can be avoided by an appropriate driving scheme. This case of the unwanted activation is also designated as “crosstalk”.

To avoid this not tolerated crosstalk, all row connections are connected in a conventional driving scheme—as known for example from US 2004/0233148 A1 or US 2002/0169675 A1—with a fixed potential, in an active resp. addressed case of a pixel with the ground, in a passive resp. non-addressed case with a higher voltage. At each activation, at first the columns are mostly pre-charged with a positive voltage (pre-charge). Then current is supplied at the column connections to the addressed row, according to the lightness of the pixels. When the intended lightness is reached, the column connections are applied by a low voltage (for the most part connected with the ground), so that the capacities are discharged, and the OLEDs of the respective pixels do not contribute to a crosstalk. Such a passive matrix-OLED-display is also described in the U.S. Pat. No. 6,351,255 B1.

As at each addressing the capacities of all OLEDs are charged, and are discharged again after the activation of the row, a bigger part of the power, required for controlling, is wasted, and the efficiency of the display decreases. Furthermore the driver chip and the display are heated by this power loss, whereby the total power loss will get possibly so high, that it can no more dissipated, and the display will heat itself. By this fact, also the display lifetime, keenly decreasing with rising temperature, will decrease. This problem escalates with the number of the addressed rows in the display, as the number of the addressing in a frame-period, in which all pixels of the display are activated once, is proportional to the row number.

In this context it is known from DE 10 2005 039 538 A1, where the post luminescence of the OLED after opening the row switch or the column switch is described, that this charge stored in the capacities of the OLEDs is to redistribute serially by circuiting with an inductance.

It is a challenge of the present invention to create an energy-efficient possibility for controlling a passive matrix OLED-display such as for a corresponding display itself.

According to the invention, this challenge is solved by the properties of claim 1 by controlling the lightness of the pixel subject to a charge quantity generated during the turn-on time of the column current, and to a charge quantity supplied from the capacity of the OLED during the post luminescence time. The benefit of this method is that the charged capacities of the OLEDs of a column release their power by emitting light via the OLED and convert this energy into useful energy. During the post luminescence time, no current injection into the column is intended. The energy required for charging the capacities is now regained, as the discharging of the capacities of the OLED is converted into light for the most part. According to the invention, the charge quantity stored in the capacity of the OLEDs before the addressing will be considered at the determination of the charge quantity converted at the OLED.

This is reached by potential-free switching the column during the post luminescence time, this means, that for example a column switch remains in an open state. In this state, the charge stored in the capacities cannot be dissipated as power loss by a current flow in the driver ship.

According to the invention, it is to the best advantage, if the lightness of a pixel occurs by adjusting the charge quantity, converted at the OLED into photon charge. This can particularly happen by regulating the duration of the turn on-time and the post luminescence time. On principle, a calculation of the turn on-time and the post luminescence time could be effected in a driver, in which the process for controlling the passive matrix-OLED-display is implemented. Due to the complexity and non-linearity of the reached lightness, in dependence on the charge quantity and the high control speed at the playing out of moving images, the duration of the turn on-times, subject to the desired lightness, can be simply stored in Look up-tables and determined by an appropriate interpolation. It is especially utile to provide for tolerances, caused by production, parameters for the dates stored in the Look-up tables.

Values can be concretely stored in the Look up-table for the charge quantity generated during the turn on-time of the column current and converted into photon charge, and for the charge quantity converted into photon charge during the post luminescence time and also for their sum for different turn on-times and post luminescence times. Then by using these values, the turn on-time and the post luminescence time can be obtained.

It is also possible to vary, according to the invention, the row addressing time subject to the lightness of subsequently controlled rows. To this, an extension of the addressing time can preferably be intended, if a controlled pixel, which follows a very light controlled pixel, shows only a low brightness. In this case, the extended row addressing time can be used to discharge the bright pixel. But the addressing time extension within the scope of the frame-time, in which each pixel of the display is once controlled, must be saved, as the total control time for the display is usually not to extend.

Furthermore it can be intended according to the invention, to vary the sequence of the addressed rows. This can be used for example, to minimize the differences in the lightness of the pixels of the subsequently controlled rows in order to avoid a variation of the row addressing times or a discharging by force, which will be explained in the following.

An external discharging of the capacities can be necessary, if the power stored in the capacities of the several OLEDs is higher than that energy required during the next row addressing. In this case it can be intended according to the invention, that a charge quantity, surplus during the addressing time, is discharged preferably on a threshold voltage, which is corresponding to a voltage on the OLED, at which no light is emitted through this OLED. This threshold voltage can be selected display-specifically and operation-specifically, whereby also the sequence of the addressed rows can be varied to avoid the forced discharging, as described above. The discharging of the surplus charge on the level of the threshold voltage leads at methods and displays resp. at drivers, implemented to control the displays, to a lower power loss and thus to the benefits, described above, even if this post luminescence time would not exist. Furthermore, a shorter charge time of the capacities immediately after the addressing is reached, so that more time will remain for the glow of the individual OLED during the control time.

According to the invention, the threshold voltage, corresponding to that voltage, with which a capacity of OLED is pre-charged without light emission of this OLED, can be determined while the passive matrix-OLED-display is under operation, for example by applying a defined current pulse and a long waiting time, until the voltage is dropped to the threshold voltage. This threshold voltage can be measured, for instance, at a micro processor and be digitalized by means of an analogue-to-digital converter integrated into the micro processor.

To avoid the accumulation of errors at the charge quantity, drawn upon—according to the invention—the specification of the lightness of a pixel and converted on the OLED, the charge states of the capacities of OLEDs can be set back to the threshold voltage after a predetermined period, which can be fixed or has to meet certain requirements. Alternatively a complete discharging of the capacities of the OLEDs is certainly possible. By this discharging to a defined state, the driver control can be brought again into agreement with the real charge states in the display.

According to a special embodiment, the capacities of the OLEDs cannot be discharged completely, but discharged to the threshold voltage after each row-addressing. Hereby it can be reached, that less parameter for the Lookup-tables must be provided, and a defined charge state in the display is existent before each addressing. The power loss, however, is significantly reduced, as a complete discharge of the capacities of the different OLEDs does not occur.

To permit a more detailed determination of the charge being available, the column voltage can be measured in a column preferably before, during or after each control, and can be considered at a charge balance of the charge quantity converted into photon charge and/or of the stored charge quantity. This makes particularly sense, if the column voltage is not set to a certain voltage before each activation and—if necessary—surplus charge is discharged before. But in the last case, the possibility of a measurement of the column voltage for inspection purposes is given.

To reach a quicker control of the different pixels in the display, a pre-charge with preferably increased charging current can be made for the duration of a pre-charge time at the beginning of the row addressing time. This pre-charge serves to the supply of the parasitic capacities until a higher OLED-voltage is achieved, from which the OLED generates light in a considerable extent.

For an effective control of the display it can be reasonable to control particularly several rows, if necessary, also several columns at the same time.

Furthermore the invention refers to a driver for controlling a passive matrix-OLED-display with OLEDs assembled in matrix form, at which the columns have separately or—if necessary—several columns or all columns simultaneously have a switch for controlling the OLEDs. This switch has the function to connect with a current source resp. to supply a voltage, such as particularly to connect with a reference voltage. Also the rows have a switch to connect with the ground and a reference potential in order that an addressing for the duration of the row addressing time can be executed in repeating sequence. The drivers are provided to influence the lightness of a pixel, located on the intersection point of a column with an addressed row, by the turn-on time being within the row addressing time, and by the amplitude of the column current. According to the invention, the driver is furthermore provided to control the lightness of the pixel, subject to a charge quantity, generated during the turn-on time of the column current, and to a charge quantity supplied from the capacity of the OLEDs during a post luminescence time. Furthermore the driver can also be provided to execute the method, described above and in the following, or to perform different steps of it.

Finally the invention also refers to a passive matrix-OLED-display with OLEDs assembled in matrix form, whereas the columns of the matrix have for controlling a switch to connect with a current source such as to connect preferably with a reference voltage. The rows of the matrix have a switch to connect with the ground and with the reference potential in order to permit the addressing in repeating sequence for the duration of the row addressing time. Furthermore a driver in the display is provided to influence the lightness of a pixel, located on the intersection point of a column with an addressed row, by the turn-on time being within the row addressing time, and by the amplitude of the column current, whereby the lightness of the pixel is to adjust subject to a charge quantity generated during the turn-on time of the column current and to a charge quantity supplied from the capacity of the OLEDs during the post luminescence time. According to the invention, this application of the proposed method resp. of the proposed driver for a passive matrix-OLED-display leads to a clearly reduced power loss of the display and so to a lower heat and increased durability of the display.

Further benefits, properties and application possibilities of the present invention also result from the following description of examples of embodiment and the illustrations. All described and/or illustrated properties constitute the topic of the present invention apart or in other configurations, also regardless of their summary in the claims or their back references.

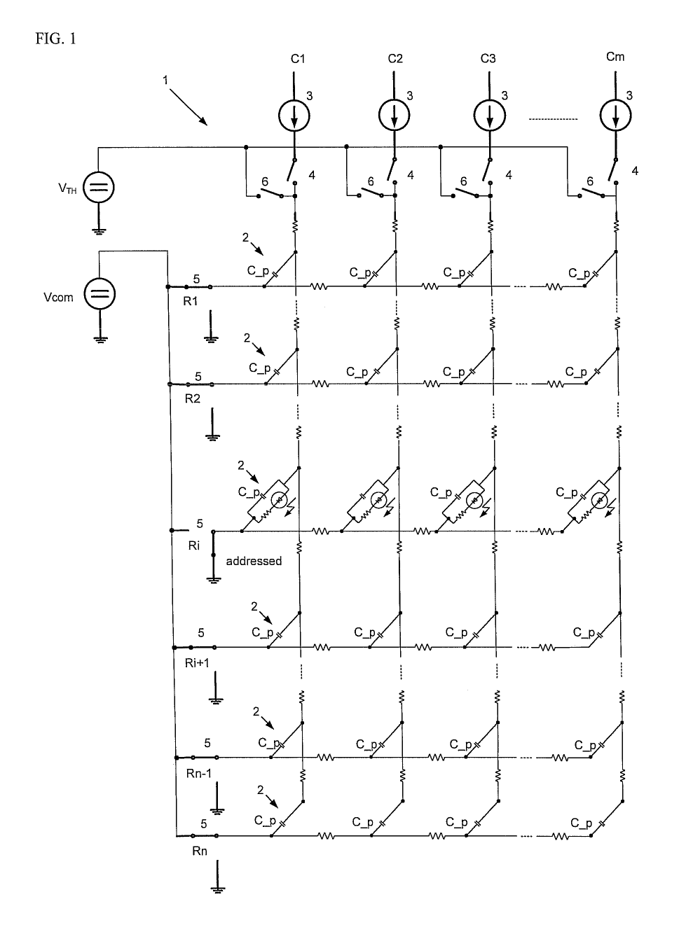

FIG. 1 an equivalent circuit for a passive matrix-OLED-display with control connections

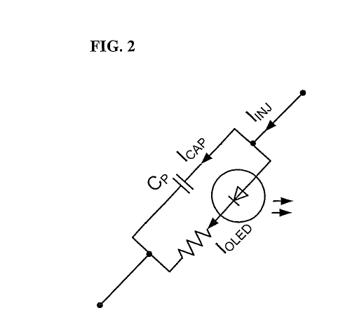

FIG. 2 an equivalent circuit of an OLED

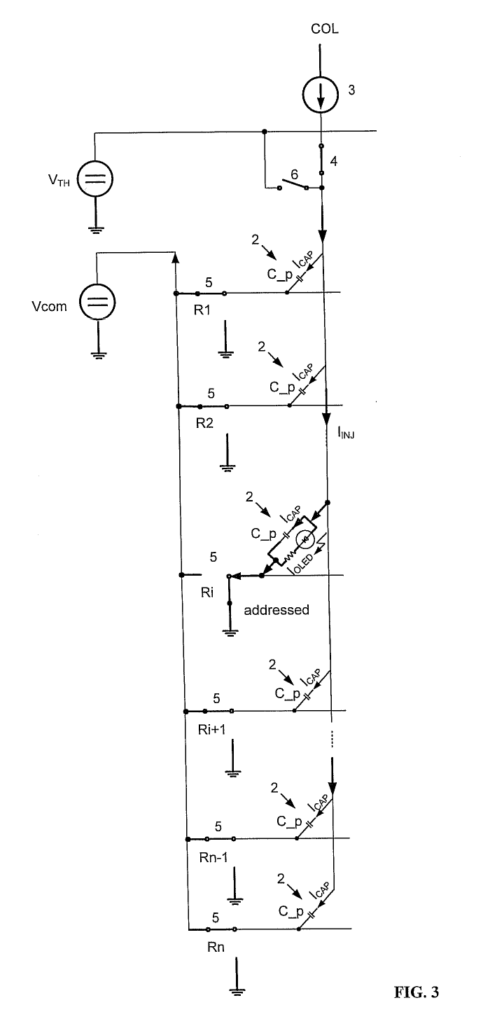

FIG. 3 a column of the display during turn-on time

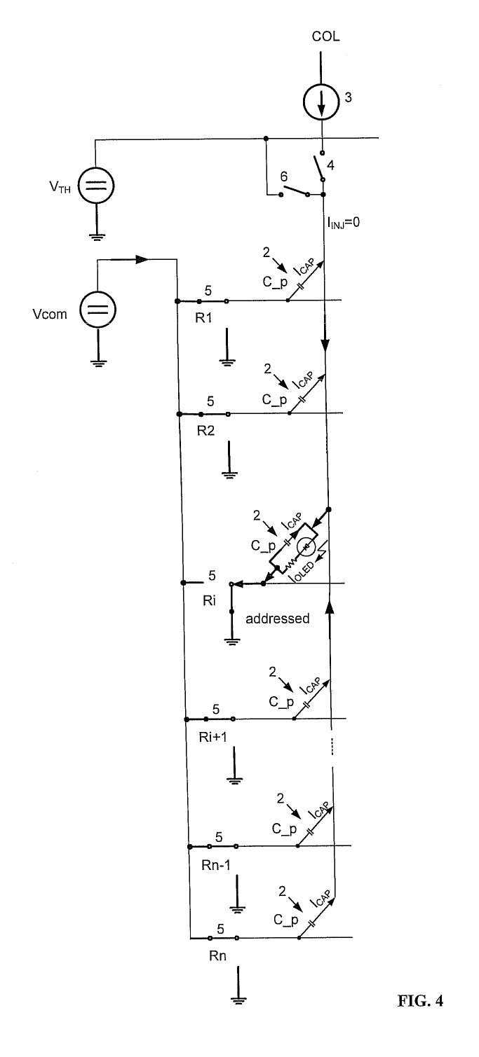

FIG. 4 a column of the display during post luminescence time

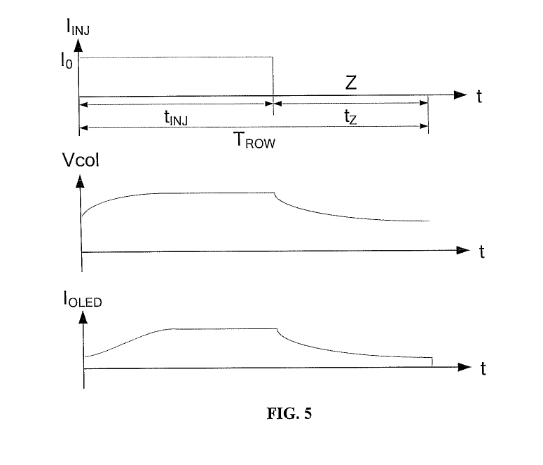

FIG. 5 transient of column current und column voltage of an OLED during row addressing time

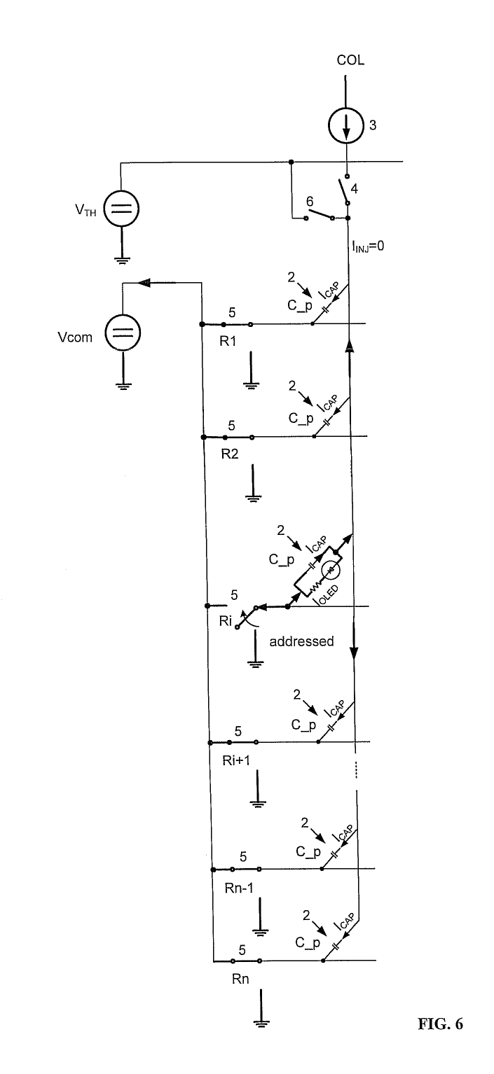

FIG. 6 a column of the display at finishing of the row addressing time

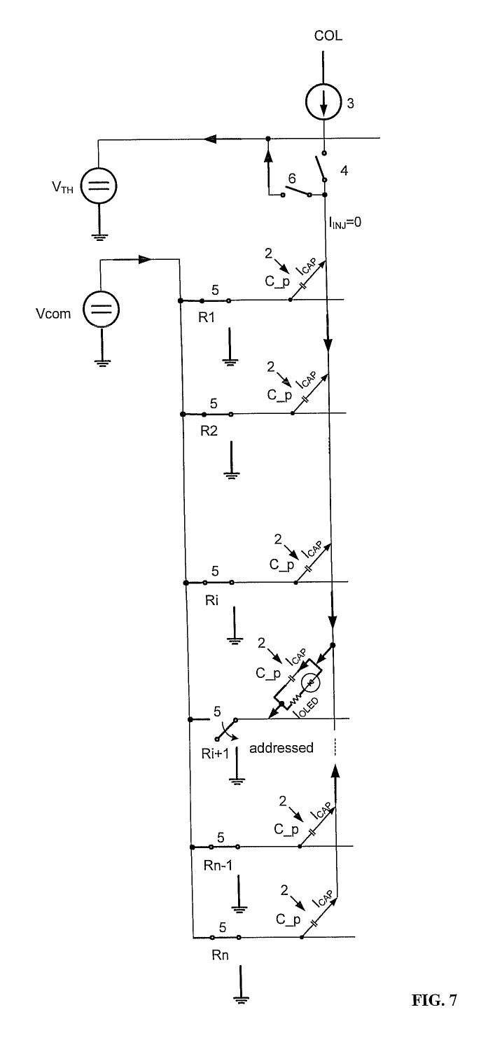

FIG. 7 a column of the display at addressing of the subsequent row

FIG. 8 the discharging of the capacities of the OLEDs after row addressing time

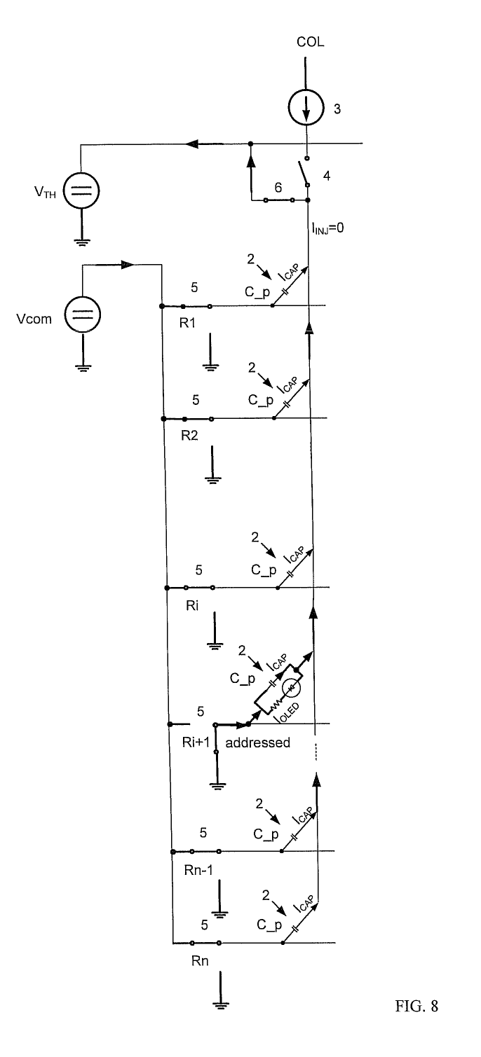

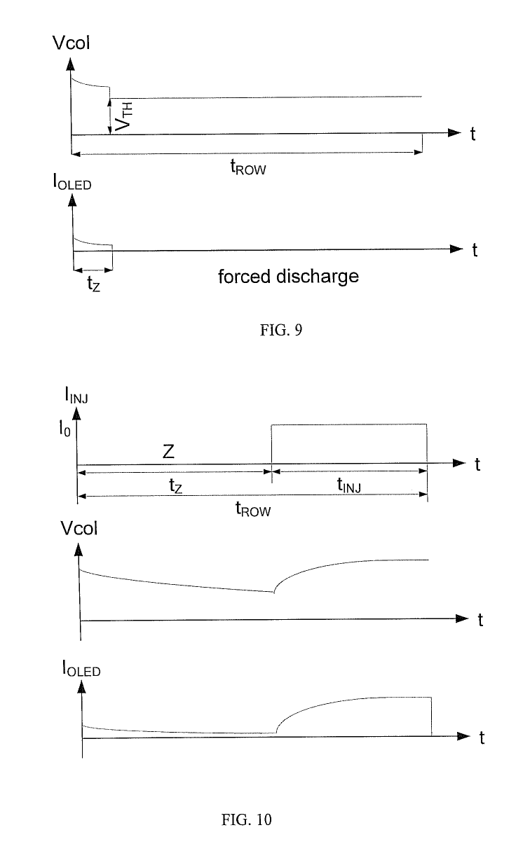

FIG. 9 the time response of the column voltage and the column current at discharging

FIG. 10 the time response of column current and column voltage of an OLED during row addressing time

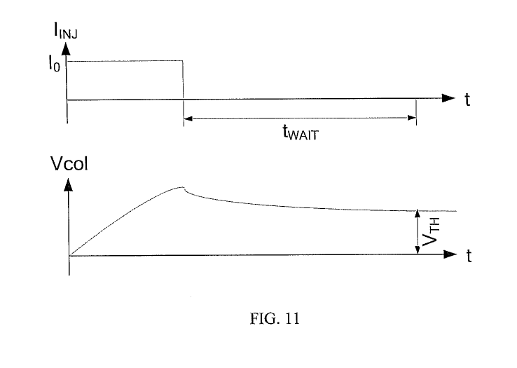

FIG. 11 a method to determine the threshold voltage

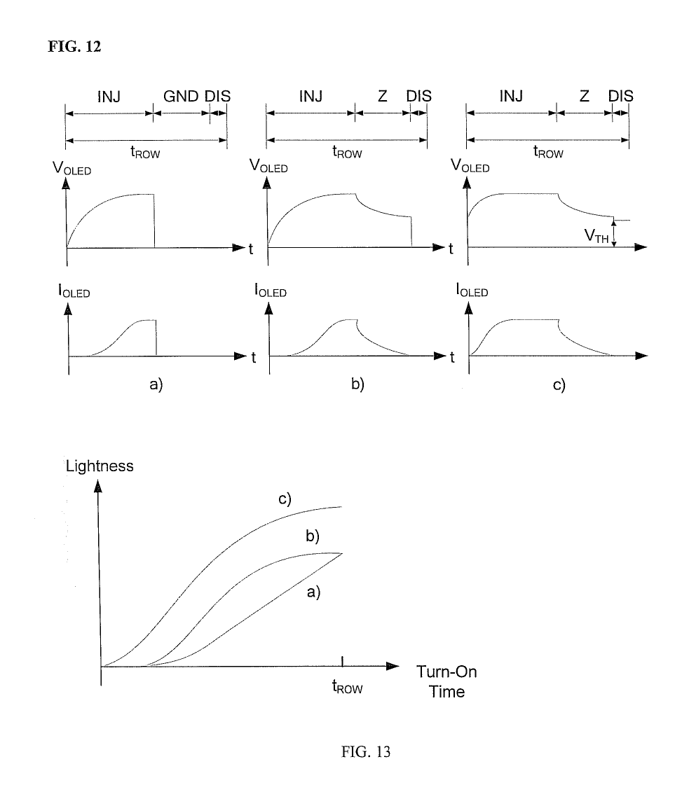

FIG. 12 the comparison of the column voltage and the OLED-current for different driving schemes

FIG. 13 a comparison of the luminance in dependence on the pulse width for the driving schemes according to FIG. 12

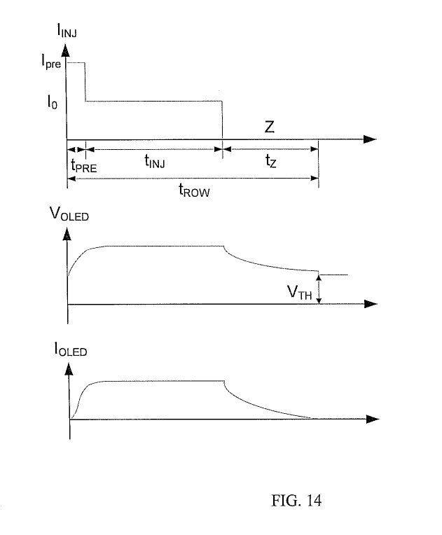

FIG. 14 the column voltage and the OLED-current in connection with a pre-charging

FIG. 1 illustrates by diagram a passive matrix-OLED-display 1 with in columns C₁ to Cₘ and n rows R₁₁to Rₙ. The whole display can have several displays of in FIG. 1 illustrated display 1, which are operated in parallel. Alternatively the display can also consist of only one display 1.

At the intersection points of the columns C and the rows R, there are in each case OLEDs 2, which can be supplied by a current source 3—assembled as constant current source of the column. For this, an appropriate column switch 4 is connected. The addressed row in each case (in the figure illustrated as Rᵢ) is connected with ground. The non-addressed rows, however, are set on a common potential V_{COM} via a column switch 5. To minimize the power loss of the OLED-leakage-currents, this potential can correspond to the OLED forward voltage according to the invention.

FIG. 2 illustrates now a simple model for an OLED-pixel. The injection current I_{INJ}, illustrated by arrows, splits into two current paths—namely a capacity current I_{CAP} into a parallel capacity C_{P} of the OLED (in the following also simply called “capacity”), in which charge is stored, and into a diode-current I_{OLED} led to the real OLED-diode, which generates in the diode a photon current, proportional to the diode current, i.e. light.

In the first approximation the generated light Lum(t) is proportional to the diode current I_{OLED}. The integration of the photon current of this pixel in photons is corresponding about to the charge Q_{LUM} converted in the OLED. Therefore the light visible to the eye is proportional to Q_{LUM} at a sufficiently high frame rate.

∫Lum(t)·dt∝∫I_{OLED}(t)·dt=Q_{LUM}

As there is no negative light, the photon charge resp. the light Lum(t) is always positive. The photon charge Lum(t) is considered as “zero”, if within a certain period (frame period) it is small in comparison with the photon charge of an illuminated pixel, so that this pixel with the lower photon charge is not realized in a display. In this case, the electrical voltage of the capacity is called as threshold voltage V_{TH} of the OLED, whereby the diode current I_{OLED} from this threshold voltage correlates to the voltage at the capacity.

The control, usually executed by a driver chip, is able to inject only the whole current, i.e. the injected current I_{TNT}. This current is the sum of the capacity current I_{CAP} and the diode current I_{OLED}. Consequently the injected charge is the sum of the capacitively stored charge and the photon charge.

I_{INJ}=I_{CAP}+I_{OLED}

The injection current I_{INJ} and the capacity current I_{CAP} can be positive as well as negative—in contrast to the always positive diode current I_{OLED}. A negative injection current I_{INJ} means, that the potential of the column in display (anode) is lowered. A negative capacity current I_{CAP} means that the before charged capacity of the diode is discharged. Therefore a diode current I_{OED} can still flow, even the injection current I_{INJ} is switched off, as the capacities of the diodes are discharged.

This effect can be used by this invention, which regulates the desired lightness L of the pixel, which is proportional to the photon charge Lum(t) in a frame period; the capacitively stored charge and/or energy is hereby converted into light.

On the basis of equivalent circuit diagram of an OLED, described before, the circuit illustrated in FIG. 1, means, that each column C is capacitively decoupled from other columns. At the same time, all capacities C_{P} of the diodes 2 are effectively shorted-circuited in this one column C. In consequence of the capacitive decoupling of the different columns, in further figures one controlled column is illustrated in place of all columns in each case.

At a closed column switch 4—as illustrated in FIG. 3—an injection current I_{INJ} flows into this column C. In static state the current flows through the addressed OLEDs 2, because the non-addressed OLEDs 2 have a much lower voltage due to the high common voltage V_{COM}, and according to the properties of the OLEDs 2 they do not conduct resp. they conduct only on a small scale, and thus they do not generate light. Therefore the voltage injected to these non-addressed OLEDs is lower than a threshold voltage V_{TH}, which defines the limit to a glow of the OLED 2.

At non-static, transient case, the capacities C_{P} of the OLEDs are, however, very important. To bring an OLED into the conducting and thus into the luminous state, the voltage at the OLED has to be increased. This means the charging of all capacities C_{P} in the column including all non-addressed OLEDs. Hereby the current flow in the current paths, as illustrated in FIG. 3 by arrows. The charging of the capacities C_{P} requires, especially at larger displays 1 with a great number of rows, a considerable lot of charge resp. energy without the immediate production of the desired power output (light). Just for a short light pulse, an essential part of time and of the injected charge is required for charging the capacities of the diodes (OLED 2) assembled in the column. As the current also flows into the voltage source V_{COM}, the charge is also stored there, i.e. from the output capacity of the voltage source.

This charge resp. energy, flown into the capacities C_{P} of the OLEDs 2 and the voltage source V_{COM} is stored. As far as no current is injected in the column C, at usual driving schemes the column connector is connected with a fixed potential (mostly ground). By this, the capacities are discharged, and the energy, dissipated in the switches of the driver chip, whereby heat is generated. This process is also called “discharge”.

After the addressing, all rows and columns on the switches 4, 5 have a defined potential, i.e. all capacities C_{P} are applied by a fixed defined voltage. This voltage must be below the threshold voltage V_{TH}, so that none of the diodes 2 will conduct and generate light. But at the addressing of the next rows, the capacities C_{P} must be recharged.

This process of discharging, described before, must be avoided as far as possible at the present invention. For this, the charge stored in the capacities C_{P} of the diodes 2 is used in such a manner, that it is not discharged by switches in the driver chip, but by the OLED 2, as shown in FIG. 4. During the row addressing time t_{ROW}, the column switch 4 is opened after a turn-on time t_{INJ}, so that the column connector stands open resp. “floated”. Now the turn-on time of the column switch 4 is not only determined by the desired lightness and by the amplitude of the injection current I_{INJ}, as in the state of the art, but also by the charge state of the capacity C_{P} in the OLED 2 before the addressing. Furthermore it depends on the time, which is required to supply the pixel, controlled by the OLED 2, with the capacity C_{P} of the diodes 2 in order to post luminescence. This time is called as post luminescence time t_{Z}.

As already mentioned, the photon charge Q_{LUM} is determined by the following equation:

$${Q}_{LUM} = {\int }_{0}^{{t}_{ROW}} {I}_{OLED} \cdot d t$$

whereas t_{ROW} is the row addressing time. The charge Q_{INJ} to be injected in order to reach this photon charge Q_{LUM} (resp. the desired pixel lightness), results from

Q_{INJ}=ΔQ_{CAP}+Q_{LUM}=Q_{CAP}_{_{—}}ᵢ₊₁−Q_{CAP}_{_{—}}ᵢ+Q_{LUM}

whereas ΔQ_{CAP} is the difference of the capacitively stored charge of row i+1 and the row i. The capacitive charge is defined by

Q_{CAP}=n·C_{P}·V_{COL}

This charge Q_{INJ}, which is to be injected, is provided by the injection current I_{INJ} during the turn-on time t_{INJ}.

Q_{INJ}=I_{INJ}·t_{INJ}

The charge Q_{INJ} is injected by the driver circuit, for which a pulse width modulation is usually applied.

The capacitively stored charge at the beginning and the end of a row addressing need not to be equal. For example, more photons than injected charges can be emitted, if the capacitively stored charges Q_{CAP} are lower at the end of the addressing than at the beginning of the addressing.

ΔQ_{CAP}=Q_{CAP}_{_{—}}ᵢ₊₁−Q_{CAP}_{_{—}}ᵢ

In the first approximation the capacitively stored charge is proportional to the column voltage and the number of diodes with their individual capacities C_{P}.

The magnitude of the actual diode current I_{OLED} correlates to the column voltage V_{COL} and to the capacitively stored charge Q_{CAP}, where also the voltage at the capacities could be used as state variable for the calculation.

At a pulse width modulated process, the constant current source 3 is used with constant current amplitude, whereby the duration of the current pulses is variable according to the desired lightness. The desired lightness is controlled in the state of the art in such a way, that the turn-on time of the column switch 4 corresponds to the desired lightness. As the lightness on a row can be different and rarely corresponds to the maximum value, most of the pixels on an addressed row have a phase, in which no current is injected.

The transient behavior of the injected current resp. of the injection current I_{INJ}, of the column voltage V_{COL} and of the diode current I_{OLED}, representing the glowing of diode 2, is illustrated in FIG. 5. I_{OLED} is proportional to the light. The whole row addressing time tam is divided into a turn-on time t_{INJ} and a post luminescence time t_{Z}.

In the first phase t_{INJ} current resp. charge is injected on the column side by the driver. All capacities C_{P} of this column are firstly charged. The injected current I_{INJ} flows into the capacities C_{P} of the diodes as well as into the diode itself to achieve a luminous effect. Successively the column voltage V_{COL} at the diode increases together with the diode current I_{OLED}. In the course of time, the column voltage V_{COL} gets nearly constant, and after charging of the capacities the injected current I_{INJ} corresponds mainly to the pure diode current I_{OLED} when the capacities C_{P} reach their maximum stationary voltage.

In the second phase t_{Z} the current source 3 is turned off by opening the column switch 4, so that the column connector remains in an open state. This has the effect, that the capacities C_{P} of the diodes 2, charged in the first phase t_{INJ}, are discharged now again in the connected column by, the diode current I_{OLED}. The column voltage V_{COL} decreases as well as the diode current I_{OLED}. Although external current is not injected, light is generated in this phase anyhow. The charge, also flowing now from the common voltage source V_{COM}, was injected in the first phase—as described before. Thus the charge flown in the first phase and not immediately converted into light, but remaining stored, can be converted into light in the second phase to increase the effective power.

If the lightness of the actually controlled pixel is small, the column voltage V_{COL} and the light current I_{OLED} do not reach the static state by the diode, so that the courses possibly do not show the plateau, illustrated in FIG. 5.

The driver circuit (control), required according to the invention, decides on the amount of the charge Q_{INJ}, which is to inject during the row addressing time t_{ROW}, and which depends on the desired lightness of the pixel as well as on the charge states of the capacities C_{P} of the diodes 2 before and after the addressing. As just mentioned, the charge states of the capacities C_{P} resp. the column voltage V_{COL} need not to be equal before and after the addressing. Their values can also be directly controlled according to the invention. Thus, the charge remaining in the capacities C_{P} shall be small or high, if the subsequently controlled pixel is dark or light.

Due to the before described control principle of the driver, the capacity C_{P} of the correspondent addressed OLED 2, however, is at the end of addressing so highly charged, that the voltage on the capacity C_{P} is above or at least at the same level as the threshold voltage V_{TH} of the diode.

After the addressing, the column switch 5, which was connected on ground during the addressing of a row, is also connected to the common potential V_{COM}, as shown in FIG. 6. This leads to a discharging of the capacity C_{P} of the just addressed diode 2. This charge is divided evenly on the capacities C_{P} of the other diodes 2 in the column; by this the column voltage V_{COL} is lightly increased.

Now the addressing of the next row follows by connecting the switch 5 of the next row to ground, as illustrated in FIG. 7 for the row Rᵢ₊₁. The capacity C_{P} of the now addressed pixel with the diode 2 is charged, as described before, while all capacities C_{P} of the remaining diodes 2 are discharged. The column voltage V_{COL} decreases at the same level as at the end of the addressing of the previous row.

The switching operations, illustrated in FIG. 6 and FIG. 7, can happen in any chronological order. Unlike the illustration before, also the column switch 5 of the subsequently connected row can be opened (i.e. connected to ground), before the column switch 5 of the previously controlled row is closed (i.e. connected to the common potential V_{COM}). The change over also can happen simultaneously.

As after opening the column switch 5 of the next row, the voltage on this OLED 2 is delivered by charging the capacity C_{P} from the capacities C_{P} of the remaining diodes 2 of the column, the column voltage V_{COL} at the now addressed diode is above or about in the same dimension of the threshold voltage V_{TH}, so that a pre-charging is not necessary. The losses due to the charge redistribution are low, regardless of the number of rows in display 1.

As at the present invention, a discharge in the control scheme at the end of the row addressing is necessary only in exceptional cases, the power loss can be kept to a minimum.

According to this invention, it will therefore be possible to make the time of the post luminescence dependent on the actual addressing time and on the lightness of the pixel of the next controlled row.

In a conventional method, the row addressing time t_{ROW} is constant and is divided evenly on all rows resp. all to be activated rows by the frame-period minus a pre-charge time or a discharge-time. Furthermore methods are known, at which the row addressing time is divided evenly on the maxima of all rows. This is also designated as FSLA (Flattened Singleline Addressing).

Within the scope of this invention, the row addressing time tam is given corresponding to FIG. 5:

t_{ROW}=t_{INJ}+t_{Z}

The minimal time for t z is proportional to

t_{Z}∝(2^{B}−1−Lᵢⱼ) or

t_{Z}∝(Max(Lᵢ₁, Lᵢ₂, . . . Lᵢₘ)−Lᵢⱼ)

whereby Lᵢⱼ is the desired lightness of the pixel it in the row i and the column j. In case of a constant row addressing time the post luminescence time t_{Z} results from the first of the both above-mentioned formulas, whereas B is the Bit-number of the grey scale (e.g. 8). The lower of the both formulas presents the post luminescence time t_{Z} in case of the Flattened Singleline Addressing (FSLA).

Of course, it will also be possible to select a longer time t_{Z}, either constant for all times or variable according to the requirements. As the increase of the post luminescence time t_{Z} reduces necessarily the duration of the current injection (or extends the frame period) and increases the current amplitude, the increase of the post luminescence time t_{Z} shall be effected only then, if this will be reasonable within the scope of the utilization of the capacitive charge. Such a case will occur, if the lightness of the actual pixel is very high (e.g. maximal), while the lightness of the subsequent pixel is very low (limit case=0). The method in such a case will be described later.

In the following, the charge balance of the method shall be presented, according to the invention.

The photon charge emerging during injection of the current resp. column current I_{INJ}, is a function of the turn-on time t_{INJ}, of the injection current I_{INJ} and of the charge of the parallel capacity Q_{CAP}, which is the charge in the capacities C_{P} of the concerned column before the addressing of the row I.

Q_{LUM}_{_{—}}_{INJ}=f_{INJ}(Q_{CAP}_{_{—}}ᵢ,I_{INJ},t_{INJ})

After injection of current I_{INJ}, the following charge remains in the capacities

Q_{CAP}_{_{—}}_{iZ}=Q_{CAP}_{_{—}}ᵢ+I_{INJ}·t_{INJ}−Q_{LUM}_{_{—}}_{INJ}

The integrated lightness, arising in the post luminescence time t_{Z}, is given by

Q_{LUM}_{_{—}}_{Z}=f_{Z}(Q_{CAP}_{_{—}}_{iZ},t_{Z})

whereby the whole lightness, emitted from the addressed pixel, is given by:

$$\begin{matrix}{Q}_{LUM} = {Q}_{LUM \_ INJ} + {Q}_{LUM \_ Z} \\ = {f}_{INJ} ( {Q}_{CAP \_ i} , {I}_{INJ} , {t}_{INJ} ) + {f}_{Z} ( {Q}_{CAP \_ iZ} , {t}_{Z} ) \\ = f ( {Q}_{CAP \_ i} , {I}_{INJ} , {t}_{INJ} , {t}_{Z} )\end{matrix}$$

Hereby Q_{LUM INJ} is the charge emitted during the turn-on time, and Q_{LUM Z} is the charge emitted during the post luminescence time. The last mentioned charge increases with the duration of the post luminescence time t_{Z}.

According to the invention, the post luminescence time t_{Z} can still be extended by an addressing time extension Δt:

t_{Z}=t_{LSB}·Max(dᵢ₁, dᵢ₂, . . . dᵢₘ)−t_{INJ}+Δt

whereby in the above-mentioned formula the first summand corresponds to the row addressing time t_{ROW}. As by the extension of the post luminescence t_{Z}, the duration of a frame shall not be increased altogether, the addressing time extension Δt within the frame must be saved again somewhere else, and must therefore be limited. The duration of the addressing time extension Δt can be selected by applying the following criterion:

Q_{CAP}_{_{—}}ᵢ₊₁=Q_{CAP}_{_{—}}_{iZ}−Q_{LUM}_{_{—}}_{Z}

Q_{CAP}_{_{—}}ᵢ₊₁≦Lᵢ₊₁

If the post luminescence time t_{Z} is long enough, the addressing time extension Δt will be selected at “zero”. Should the lightness of a pixel be very high, and the lightness of the subsequently controlled pixel should be very low, a relatively high addressing time extension Δt can be necessary. Hereby the addressing time extension Δt should be limited in such a way, that the following equation is approximately satisfied:

$${Q}_{LUM \_ Z} = {f}_{Z} ( {Q}_{CAP \_ iZ} , {t}_{Z} ) \leq \frac{1}{2} \cdot {I}_{INJ} \cdot {t}_{Z}$$

whereby the parameter ½ is arbitrary and can be substituted by another number between 0 and 1. The smaller number for the addressing time extension Δt among the above mentioned formulas is used, unless a fixed addressing time extension Δt is selected.

The remaining charge is still determined by

Q_{CAP}_{_{—}}ᵢ₊₁=Q_{CAP}_{_{—}}_{iZ}−Q_{LUM}_{_{—}}_{Z}

and can violate the condition, established in

Q_{CAP}_{_{—}}ᵢ₊₁≦Lᵢ₊₁

In this case, a forced discharge is necessary.

For this, the discharging switch 6 is closed to discharge the capacities C_{P} of the diodes 2 in the column. But hereby the column potential is not reduced to zero resp. to ground, as in the state of the art, but only to the threshold voltage V_{TH} of the OLEDs. The discharging of the capacities C_{P} is illustrated in FIG. 8.

It is utile to carry out the forced discharging of the capacities C_{P} during the subsequent row addressing. If the lightness of the subsequent pixel is zero in extreme case, the column connection with the next addressing, at which the row switch 5 for the row Rᵢ₊₁ is connected on ground, will be discharged on the threshold voltage V_{TH}. Otherwise a post luminescence time t_{Z} for the row i+1 after addressing of the row i+1 must be awaited, until the following equation is valid:

Q_{LUM}_{_{—}}_{Z}(i+1)=f_{Z}(Q_{CAP}_{ᵢ₊₁},t_{Z}_{_{—}}ᵢ₊₁)=Lᵢ₊₁

whereby the desired lightness of the pixel in the controlled column and the addressed row i+1 corresponds to photon charge Q_{LUM Z} emitted during the post luminescence time. When the desired lightness L in the post luminescence time t_{Z} of row i+1 is reached, the column connection is lowered to the threshold voltage V_{TH}.

So the capacitively stored charge Q_{CAP} is firstly exploited at a maximum. Then the forced discharging will occur during the addressing of the next row, so that additional time will not be required. The time response of the column voltage resp. diode voltage V_{COL} and of the diode current I_{OLED} is illustrated in FIG. 9. After discharging the charge state of the column voltage V_{COL} is exactly

V_{COL}=V_{TH}

A forced discharge should be avoided as far as possible, as hereby undesired losses can occur. Therefore it is proposed according to the invention, to select the order of the addressed rows variably and not according to their geometric arrangement. As a forced discharging is usually necessary at the time, when the preceding pixel is very light and the subsequent pixel is very dark, and at in reversed order—when a pixel is firstly dark an then light—a forced discharge would not be necessary, the order of the addressed pixels can be arranged in such a way, that the total number of the forced discharges is minimal. According to the invention, a certain number of subsequent addressing in the memory chip can be considered.

Because the diode current I_{OLED} is not constant, as described in FIG. 5, the emitted light is also not linearly proportional to the turn-on time t_{INJ}, which determines the time of the injected current I_{INJ}. In fact, the lightness also depends on the duration of the post luminescence in the post luminescence time t_{Z}. The post luminescence phase is as long as the row addressing time t_{ROW} less the turn-on time t_{INJ}. While the row addressing time t_{ROW} is equal for all pixels on a row, the duration for the post luminescence t_{Z} is different from pixel to pixel and from column to column. In consequence, the states of the capacities C_{P} are different in each column. In addition, the duration of the current injection t_{INJ} has to consider the initial state. To this, there are three possibilities for the driver to control the display 1. At first, the injected charge Q_{INJ} can usually be varied by a constant current amplitude and a variable pulse width. Then, a post luminescence time t_{Z} is provided, in which a light-emitting discharging of all capacities C_{P} is effected by a high-impedance column driver. The next step is a forced column discharge on the threshold voltage V_{TH} of the OLED.

At all these possibilities it is important to ensure, that the desired lightness L of the appropriate pixel is reached, and simultaneously all capacities C_{P} of the diodes 2 are discharged at the end of the addressing on and/or below the requested state for the lightness of the next pixel by post luminescence resp. by discharging.

The photon charge Q_{LUM} equivalent to the emitted light is a function of the charge state of the parallel capacity Q_{CAP}, of the amplitude of the injection current I_{INJ}, the turn-on time t_{INJ}, which determines the duration of the current injection and the post luminescence time t_{Z}:

Q_{LUM}=f(Q_{CAP}_{_{—}}ᵢ,I_{INJ},t_{INJ},t_{Z})=Lᵢ

The remaining charge after the addressing is:

Q_{CAP}_{_{—}}ᵢ₊₁=Q_{CAP}_{_{—}}ᵢ+Q_{INJ}−Q_{LUM}

The control for passive matrix-OLED-displays 1 according to the invention, sets correspondingly the charges whereby the turn-on time t_{INJ} and the row addressing time t_{ROW} are the control variables, which can be controlled in a driver chip exactly, simply and with high resolution. The post luminescence time t_{Z} results from the subtraction of the turn-on time t_{INJ} from the row addressing time t_{ROW}.

The function determining the lightness L for the photon charge is, however, not linear and also depends on the diode capacity C_{P} and the DC characteristics of OLED, which are individual, but nearly constant for each display. Thus, for each display type there is a specific function with an own multi-dimensional course. Therefore a calculation of the turn-on time t_{INJ} and the post luminescence times t_{Z} can be reached only heavily due to the non-linearity and the complexity of the calculation in memory chips of usual processing power.

This dependence, however, can be determined previously by measurement of the display 1 resp. a simulation, and can be stored as Lookup-table in the driver, e.g. in a memory of the driver chip. By this, a linear conversion of the desired lightness is possible in spite of the high capacity.

In case, that the lightness of the subsequent pixel to be addressed is high, it is reasonable to start the post luminescence phase, i.e. the post luminescence time t_{Z}, before the current injection, as shown in FIG. 10. Also this case is a matter of “post luminescence”, as the remaining charge of the previous addressing post luminescence now. The advantage is, that the capacities C_{P} of the diodes are charged high at the end of the row addressing time t_{ROW} before the next row will be addressed by a light pixel. So the next pixel can begin quickly with the light generation. The time required for this is minimized. In this case, the emitted light is another, non-linear function:

$${Q}_{LUM \_ Z} = {f}_{Z} ( {Q}_{CAP \_ i} , {t}_{Z} )$$

$${Q}_{CAP \_ iZ} = {Q}_{CAP \_ i} - {Q}_{LUM \_ Z}$$

$${Q}_{LUM \_ INJ} = {f}_{INJ} ( {Q}_{CAP \_ iZ} , {I}_{INJ} , {t}_{INJ} )$$

$$\begin{matrix}{Q}_{LUM} = {Q}_{LUM \_ Z} + {Q}_{LUM \_ INJ} \\ = g ( {Q}_{CAP \_ i} , {t}_{Z} , {I}_{INJ} , {t}_{INJ} ) \\ = {L}_{i}\end{matrix}$$

Also this dependence can be converted as a Lookup-table, so that the duration of the current injection t_{INJ} can be taken at a given current amplitude, desired lightness and last charge state of the parallel capacity and at selected duration of the post luminescence time. The charge conservation, indicated before, remains valid.

In a further embodiment of the method, the post luminescence time t_{Z} can be divided into two phases, i.e. firstly a discharge will happen, then a current injection, and finally another second discharge will follow.

As the Lookup-tables have many input variables, a high memory requirement can be necessary altogether. This memory requirement can be considerably reduced by a linear approximation and a thinning of the Look-up table, if only few sample points are selected for an input variable, and the intermediate values are to calculate by interpolation.

In the previous examinations, the diode current I_{OLED} of all non-addressed pixels was neglected. In reality, however, an appropriate current usually being low according to the quality of OLEDs flows. But should the number of rows of display 1 be high, the leakage current has to be possibly considered in the charge balance, as obvious the following:

Q_{INJ}=Q_{CAP}_{_{—}}ᵢ₊₁−Q_{CAP}_{_{—}}ᵢ+Q_{LUM}+(n−1)·I_{Leck}·t_{ROW}

whereby the leakage current I_{LEAK} is the current through a non-addressed diode.

This current can be positive or negative, subject to the common potential V_{COM}. The current also depends on the voltage i.e., above all on the magnitude of the common potential V_{COM}. This current is mainly a leakage current. The photon current rate I_{OLED}, basing on a charge recombination, is low.

Consequently, the common potential V_{COM} shall be dimensioned in such a manner, that it is about so large like the column voltage V_{COL}, i.e. the typical mean value of the column voltage. By this, the leakage current I_{LEAK} is minimized and approaches zero, so that the leakage current I_{LEAK} is not to consider in this case. Otherwise the last term of the above-mentioned formula should be included into the charge balance. Also the leakage current can be estimated as constant value or can be seen from a simple Lookup-table, subject to the common potential V_{COM}, and/or to the current amplitude

The threshold voltage V_{TH} is a sensitive value and can vary from display to display even at the same type. Particularly it also depends on the actual temperature of display 1. Therefore the determination of the actual value of the threshold voltage V_{TH} in regular intervals is reasonable.

A first value can be determined by switching on the display. This is illustrated in FIG. 11. To this, a pixel is addressed, and a defined current pulse is injected. The total charge shall be so large, that the addressed pixel flashes up shortly. After the current pulse a long waiting time is kept, during which the voltage V_{COL} of the column drops off to the threshold voltage V_{TH}. Then the voltage can be determined for example by an analogue-digital-converter, which can be integrated into a driver chip. The result is fixed as threshold voltage V_{TH}, and the value for the discharging-voltage-source will be adjusted.

As the temperature of display 1 changes during operating, a continuous determination of the threshold voltage V_{TH} can be reasonable. For example, the threshold voltage V_{TH} can be determined once in each frame. In addition, an artificial waiting time can be added to a row, and a column voltage V_{COL} of a column, which was previously not subject to a forced discharge, can be measured. In principle, it is possible to adjust the frequency of the actualization of the threshold voltage V_{TH}, and to increase or to reduce it. In the same way another pixel can be measured at an actualization to avoid systemic errors, for example by the defect of a specific pixel.

The method according to the invention for controlling a passive/matrix-OLED-display 1 of this invention is based on the determination of the charge Q_{LUM} (photon charge). In the course of time, errors can accumulate at the determination of the photon charge Q_{LUM}, i.e. the discrepancy between the measured and the real charge for the injection and generation of light can increase. This can lead to a reduction of the quality of the illustration of display 1, if the discrepancy is too large. Discrepancies, smaller than 1%, are usually not realized.

As the photon charge Q_{LUM} is continuously calculated and transmitted, there is a risk of accumulating these errors, which get visible then. In this case, a regular resetting of the control would be helpful. This can be done one time per frame by adjusting all column voltages V_{COL} to the threshold voltage V_{TH} after a completion of each frame i.e. after a complete control cycle for the display 1. Shorter or longer time intervals are certainly also possible.

Variations of the display properties, caused by production, such as the extent of the diode capacity C_{P} or the DC characteristics are a further error source. Resulting errors can be eliminated or minimized by a calibration at the production by means of quotients for the Lookup-table.

As the charge capacity resp. the charge state Q_{CAP} is correlated to the voltage V_{COL}, also a measurement of the column voltage V_{COL} can provide valuable information regarding the charge state. The deviation between the calculation by a Lookup-table and the measurement of the column voltage V_{COL} also implicates a deviation of the capacity C_{P} and the Dc characteristics of the OLED. The reason can be found among other things in the variation concerning the production, but also in the operating temperature. Therefore the measured values of the column voltage V_{COL} can be implicated into the calculations, so that the control of the display will get more exactly.

As it is costly to implement a Lookup-table with many input variables, the driver scheme applied at the method according to the invention can be simplified in such a manner, that the columns are discharged on the threshold voltage V_{TH} after the addressing of a row. The disadvantage of a power loss is given here. But the advantage is, that the charge state is in each case constant and defined before the addressing of a new row. The post luminescence, according to the invention, in the post luminescence time t_{Z} will continue to be applied, and furthermore the column voltage V_{COL} is only discharged on the threshold voltage V_{TH}, but not to zero. Therefore such a method still provides an essential economy of the power consumption with regard to the state of the art.

A conventional Singleline-Addressing (SLA) with a constant row addressing time will also continue to reduce the dependence. In this case the formula

Q_{LUM}=f(Q_{CAP}_{_{—}}ᵢ,I_{INJ},t_{INJ},t_{Z})=Lᵢ

has only two input variables, even the desired pixel-lightness L and the current amplitude I_{INJ}, corresponding to the global lightness of the display.

In FIG. 12 can be seen the transients of column voltages V_{COL} at a diode 2 and the diode currents I_{OLED} for a conventional SLA-driver scheme with individual switching of the pixels on ground potential at the end of the active time (state of the art, case a) such as their optimization by introducing the high-impedance column state in the post luminescence time (case b) and a discharge voltage-level on the threshold voltage V_{TH} of the OLEDs (case c). At same injected charge, proportional to the turn-on time t_{INJ}, and thus to injected energy, the integral will increase via the diode current I_{OLED}, and thus the generated light quantity will increase, too.

The determination of the required injection time t_{INJ} is considerably simplified because of the invariable conditions of the constant row addressing time and the constant initial charge in order to realize a linear lightness conversion (gamma-correction).

The direct comparison of the achieved luminosity is illustrated in FIG. 13, in which the obtained lightness is shown as function of the turn-on time (pulse width) of the injected current for the three above mentioned driver schemes.

For each discrete lightness value, a corresponding turn-on time t_{INJ} is taken to guarantee a linear lightness generation. The driver scheme according to the invention can be combined very well with the control described in DE 10 2005 063 159, whereby further Lookup-tables for two- and multiline-addressing are necessary. Now the row addressing time t_{ROW} is no more constant, but variable.

As at the beginning of the addressing, the injection current I_{INJ} flows primarily into the parasitic capacities and thus light is not generated, a sufficient injection time (turn-on time t_{INJ}) has to be given also for the smallest lightness. As a result, the row addressing time t_{ROW} is extended by the linearization.

Thus the variable row addressing times would shorten the reduction of the current amplitude; but this would counteract, however, the advantages of the present method. Therefore it is stipulated according to the invention, to provide in the row addressing time t_{ROW} a pre-charge time t_{PRE} (pre-charge-phase), preceding the real turn-on time (t_{INJ}). This is shown in FIG. 14.

Hereby the OLEDs are supplied with a short current impulse with a larger amplitude during the pre-charge time t_{PRE}, so that the parasitic capacities C_{P} of the OLEDs 2 are charged more quickly, and the light can be generated by a lower delay. The pre-charge time t_{PRE} is so dimensioned, that in this phase only minimal light is generated. To this it is guaranteed, that the generated light quantity does not exceed the lowest adjustable lightness.

The current controlled pre-charging can be implemented well, particularly within the scope of the multiline-addressing, as described in DE 10 2005 063 153, because higher anode currents must be secured anyway in this case. Of course, the pre-charging can also be adjusted by defined voltage and by defined duration.

The pre-charging-phase t_{PRE} and the current injection phase t_{INJ} are certainly not to apply, if the pixels are dark. The pre-charging time t_{PRE} and the pre-charge current I_{PRE} can be selected in such a way that the hereby generated lightness L is smaller than one and a half times of the smallest lightness value. The benefit of the pre-charging is that the necessary row addressing time tam is altogether lower, so that the current amplitude can strongly be reduced at variable row addressing times.

Altogether the energy efficiency of passive matrix-OLED-displays is essentially increased by introducing the stipulated post luminescence time according to the invention.

### LIST OF REFERENCE NUMERAL

1 Display
2 Diode, OLED
3 Constant Current Source
4 Column Switch
5 Row Switch
6 Discharge Switch
V_{COM} Common Potential
V_{TH} Threshold Voltage
I_{INJ} Injection Current
I_{CAP} Capacity Current
I_{OLED} Diode Current
I_{PRE} Pre-charge Current
C_{CAP} Parallel Capacity
Q_{LUM} Photon charge
Q_{INJ} Injected Charge
Lum(t) Light
t_{INJ} Turn-on time
t_{Z} Post luminescence Time
Δt Addressing Time-Extension
t_{ROW} Row-Addressing-Time
t_{PRE} Pre-charge Time
Q_{CAP} Capacitively Stored Charge
C_{P} Diode Capacity
V_{COL} Column Voltage
L Lightness, Luminosity
I_{LEAK} Leakage Current

1. A system for controlling a passive-matrix-OLED-display comprising:
OLEDs assembled in matrix form of rows and columns, wherein the columns for controlling an OLED are connected with a current source and the rows are connected consecutively one after another for the duration of the row addressing time, wherein a lightness of a pixel located on the intersection point of a column with an addressed row influenced by the turn-on time being within a row addressing time and by the amplitude of the column current,
and that the lightness of the pixel is controlled subject to a charge quantity converted into light during the turn on-time of the column current and to a charge quantity supplied and converted into light from the capacities of the OLEDs during a post luminescence time by switching the column potential-free during the post luminescence time (t_{Z}) and for the determination a charge quantity converted at the OLED the charge quantity stored in the capacity of OLEDs before the addressing is considered.

2. The system according to claim 1, wherein the control of the charge quantity (Q_{LUM}) converted on the OLED is effected by adjusting the duration of the turn-on time (t_{INJ}) and the post luminescence time (t_{Z}).

3. The system according to claim 1, wherein the values for the charge quantity (Q_{LUM}_{_{—}}_{INJ}) converted into light and generated during the turn-on time (t_{INJ}) of the column current (I_{INJ}) and for the charge quantity (Q_{LUM}_{_{—}}_{Z}) converted into light during the post luminescence time (t_{Z}) and/or their sum (Q_{LUM}) for different turn-on times (t_{INJ}), post luminescence times (t_{Z}), current amplitudes (I_{INJ}) and/or charge states (Q_{CAP}, V_{COL}) are stored in a Lookup-table.

4. The system according to claim 1, wherein the row addressing time (t_{ROW}) is varied subject to the lightness (L) of rows subsequently controlled.

5. The system according to claim 1, wherein the order of the rows is varied.

6. The system according to claim 1, wherein a surplus charge quantity (Q_{CAP}) is discharged during a row addressing time (t_{ROW}), if the energy stored in the capacities of the respective OLEDs is higher than the energy required during the next row addressing.

7. The system according to claim 6, wherein a threshold voltage (V_{TH}) is determined while the passive matrix-OLED-display is operating.

8. The system according to claim 1, wherein the charge (Q_{CAP}) of the capacities (C_{P}) of the OLEDs will be reset after a predetermined period.

9. The system according to claim 6, wherein the capacities (C_{P}) of the OLEDs are discharged on the threshold voltage (V_{TH}) after each row-addressing.

10. The system according to claim 1, wherein the column voltage (V_{COL}) is measured in a column and is considered at a charge balance of the charge quantity converted into photon charge (Q_{LUM}) and/or of the stored charge quantity (Q_{CAP}).

11. The system according to claim 1, wherein a pre-charge is effected for the duration of a pre-charge time (t_{PRE}) at the beginning of the row addressing time (t_{ROW}).

12. The system according to claim 1, wherein several rows and/or columns of the display are controlled simultaneously.

13. Drivers for controlling a passive matrix-OLED-display, comprising:
OLEDs assembled in matrix form, wherein the columns of the matrix-shaped assembled OLEDs for controlling the OLED have a switch for connecting with a current source and for connecting with a reference voltage and rows of the matrix-shaped assembled OLEDs have a switch for connecting with ground and with a reference potential for an addressing in repeating sequence for a duration of the row addressing time furthermore with a driver, established for influencing a lightness of a pixel, located on an intersection point of a column with an addressed row, by a turn-on time being within the row addressing time and by an amplitude of the column current wherein that the driver is equipped to control the lightness of the pixel subject to a charge quantity converted into light during the turn-on time of the column current and subject to a charge quantity supplied by the capacities of the OLEDs and converted into light during the post luminescence time by switching the column potential-free during the post luminescence time and by considering the charge quantity stored in the capacity of OLEDs before the addressing at determination of the charge quantity converted at the OLED.

14. A passive matrix-OLED-display, comprising:
OLEDs assembled in matrix form, wherein the columns of the matrix-shaped assembled OLEDs for controlling the OLED have a switch for connecting with a current source and for connecting with a reference voltage, and the rows of the matrix-shaped assembled OLEDs have a switch for connecting with a ground and with a reference potential for an addressing in repeating sequence for a duration of a row addressing time and a driver, equipped for influencing a lightness of a pixel, located on an intersection point of a column with an addressed row, by the turn-on time being within a row addressing time and by an amplitude of a column current, wherein the driver is equipped to control the lightness of a pixel subject to a charge quantity converted during a turn-on time of the column current and to a charge quantity supplied by the capacities of the OLEDs during a post luminescence time by switching the column potential-free during a post luminescence time and by considering a charge quantity stored in the capacity of the OLEDs before the addressing at determination of the charge quantity converted at the OLED.
